(19) United States
(12) Patent Application Publication
(10) Pub. No.: US 2018/0022241 A1
(43) Pub. Date: Jan. 25, 2018

(54) Portable Child Safety Seat with Five-Point Restraint

(71) Applicant: Dagmar Gunilla Jewkes, Heber City, UT (US)

(72) Inventor: Dagmar Gunilla Jewkes, Heber City, UT (US)

(21) Appl. No.: 15/215,593

(22) Filed: Jul. 21, 2016

(51) Int. Cl. B60N 2/28

(52) U.S. Cl. CPC B60N 2/2812; B60N 2/2806; B60N 2/2866; B60N 2002/2896

(57) ABSTRACT

The present invention combines the benefits of a booster seat with those of a five-point restraint to provide a compact, portable, lightweight car seat with a five-point harness. The invention consists of a seat-bottom and a backplate. It provides simple installment using either LATCH or the vehicle's adult shoulder-lap belt, with infinite height adjustment of the child's shoulder harness anchors requiring only two belt-length adjusters. A criss-cross connection between seat-bottom and backplate reduces excursion and injury in side impacts. A double-loop connector minimizes incorrect installation. The child's harness has been completely rerouted to lower production cost and to reduce misuse of the restraint. The seat cover can be easily removed without the need to replace any belt webbing, and can be used as a storage compartment for the back-plate, five-point harness and tethers. The cover contains handles, such that it can be carried like a tote.

### FIELD OF THE INVENTION

The present invention is in the technical field of passenger restraint systems for use in motor vehicles. More particularly, the present invention is in the technical field of portable add-on restraint systems for juvenile occupants of motor vehicles.

### BACKGROUND OF THE INVENTION

In collisions, vehicle acceleration and compartment intrusion play major roles in causing injuries to occupants. Acceleration may cause restraint-related injuries or, when excessive, may cause the ride-down space to be insufficient to prevent impact between the occupant body and vehicle interior. Intrusion causes a reduction of ride-down space and may further increase the impact speed between the occupant's body and the vehicle interior. (Jewkes et al. 1998.)

The purpose of child safety restraints is to reduce injury by maximizing ride-down space, minimizing interaction with (intruding) vehicle interior components and preventing ejection. (Viano and Parenteau, 2010.) Slavik et al. (1997) found that children sustained neck injuries only when accompanied by head impacts, while head impacts more often occurred when the thoracic restraint was missing or inefficient. Fuchs et al. (1989) and Kelleher-Walsh (1993) confirmed that neck injuries to children in frontal collisions is extremely rare when correctly restrained and no head impact occurred.

Arbogast et al. (2002) estimated the effectiveness of child restraints to be as much as 80% in reducing fatalities, provided that the correct restraint is chosen (e.g., infant seat or booster seat) and the restraint is used properly. Prematurely moving a child from a car seat with five-point restraint to a booster and/or adult seat belts may greatly compromise the child's safety. Unfortunately, research has shown that approximately 75% of all child restraints are used incorrectly, either by choosing an inappropriate restraint type, incorrect installation of the seat and/or child, or loose fit of mounting system and/or child harness.

Currently, there are two basic types of car seats: the child restraint system with a five-point harness (“CRS”) which can be both forward and rearward facing, and the belt positioning booster (“BPB” or “booster”) which is used in conjunction with the adult seat belt in a forward-facing manner. The present invention combines (1) the five-point harness feature of the CRS with (2) the lightweight, compact, and ease-of-use characteristics of the booster, to create a new breed of portable child safety seat.

### SUMMARY OF THE INVENTION

A child safety seat is an automobile accessory designed to protect an infant and/or child in a motor vehicle through physical elevation, additional restraints, additional padding and other features that ensure safety and protection from injury or death during a collision. There are two orientations of child safety seats: forward-facing and rear-facing. Most forward-facing, add-on child restraint systems fall within two categories: car seats with a five-point harness, and belt-positioning booster seats. The present invention combines the five-point belt system of the car seat with the versatility of the booster to yield a lightweight, portable child safety seat with five-point restraint.

Car seats generally include a hard shell composed of a seat-bottom with a rigidly connected back support that is placed on the horizontal seating surface of the vehicle. The child is typically restrained sitting within the hard shell by a five-point harness, which includes a webbing strap over each shoulder, one on each side of the pelvis, and one between the legs, with all five coming together at a common buckle located in the crotch area. Car seats, which are generally recommended by manufacturers for toddlers and preschoolers typically between two and seven years old, can be effective in restraining children traveling in motor vehicles because of their use of the five-point restraint system and because they fix the shoulder strap location via the hard-shell back support. The five-point harness generally consists of two belt straps that are routed through the interior of the car seat in a cumbersome manner. Each strap originates from the underside of the seat-bottom, is routed through a hip slot in the seat-bottom, through a latch plate and possibly a portion of a shoulder clip, through one of a set of shoulder slots in the seat back portion (generally located at three to four different heights), and finishes by attaching the end of the strap to a metal plate which is located behind the child seat's back. The metal plate has another belt strap attached to its bottom, such that a total of three belt straps are connected to the metal plate. The bottom belt strap is then routed down behind the seatback, continues under the seat-bottom and through an opening generally located in the front center portion of the child seat-bottom. This opening contains a locking device, such that the bottom strap can be used to adjust the length of the five-point harness by pulling the bottom belt strap and locking it in place.

Car seats have, however, a number of critical drawbacks. Most importantly, car seats are bulky and heavy, reducing the portability of the safety restraint and possibly causing parents to compromise the safety of their child (such as when traveling away from home) by prematurely moving them to booster seats or adult seat belts. The belt routing used by modern car seats is complex and typically employs multiple straps and lengthy webbing. Their bulk and complexity also make car seats difficult to clean and install, frequently leading to incorrect use and introducing movement of the seat with respect to the vehicle. Indeed, studies show that approximately seventy-five percent of all car seats are improperly installed. (Decina & Lococo, 2003.) These characteristics also mean that car seats tend to be more expensive. The size of the car seat also reduces the space between the child and the front seat of the vehicle, which can increase risk of head impacts with the interior, and as such can lead to increased injury in frontal collisions. Finally, because the seat-bottom is rigidly connected to the back support, the bottom and back support move in tandem, such that both lower and upper harness anchors move together in certain accident events. This may lead to increased belt slack and injury risk to the child.

A booster seat, on the other hand, generally consists of a raised cushion placed on the horizontal seating surface of the vehicle, which theoretically enables the child to use the conventional adult three-point safety belt installed in the vehicle. Booster seats, which are generally recommended by manufacturers for children typically between four and twelve years old, are convenient because they are lightweight and compact, are easier to install than car seats, lack additional webbing, and do not require a supplementary restraint system. Because of their relative simplicity, smaller size and fewer component parts, booster seats are generally less expensive than car seats.

Booster seats also have, however, a number of critical drawbacks. Most importantly, studies have shown that booster seats are statistically less effective than properly used five-point restraints in preventing injuries to children in accidents, particularly for children weighing less than forty pounds, in the case of side collisions and in rollover events. (NHTSA Report to Congress on Improving the Safety of Child Restraints-Booster Seat Study, 2002.) Much of this risk is due to the fact that, unlike a car seat with a five-point restraint, a booster seat has fewer anchor points, which enables sliding of the upper body out of the shoulder belt and entails increased ejection risk. Furthermore, the booster does not rigidly fix the position of two shoulder belts on the child, allowing for additional belt slack and accompanying injury risk increase.

While car seats and booster seats can, respectively, be effective for their intended purposes, when installed and used properly, there is a need for a new child restraint design that effectively combines the safety of a five-point restraint and rigid belt anchors, as commonly found in car seats, with portability, reduced size and ease of installation, as commonly found in booster seats. The new design in the instant application fills that need.

The present invention is a portable, light weight, and easy to install forward facing five-point child safety seat that utilizes an independent child shoulder belt anchor positioner. The child safety seat may be used for children between two and ten years of age. It may be used with either the three anchors from the Lower Anchors and Tethers for Children (“LATCH” system) or with a conventional three-point seat belt system in a folding vehicle seat. The shoulder belt anchors can be easily positioned at any height of choice by a rigid seat back-plate, and kept fixed in their positions independently from the crotch and pelvic belt anchors throughout a wide range of motor vehicle accidents. The back-plate may be installed using the LATCH anchors or the shoulder portion of the adult seat belt. The unique design of a seat back-plate that can be adjusted relative to the seat-bottom allows for independent positioning of the child's shoulder belt anchors relative to the child's lower belt anchors. The child's crotch and pelvic belt anchors are positioned by a small seat-bottom, like a booster seat, which has a buckle mounted in its center, and may be latched into the vehicle with the lower LATCH anchors or the lap portion of the adult seat belt. The seat-bottom contains strong armrests, which create a snug fit with most adult seatbacks, and prevent upward rotation of the seat-bottom.

Additionally, the one-of-a-kind design, mounting system, belt routing and configuration of the back-plate allows for easy installation, quick adjustments of the child's shoulder belt anchor height for adaptation to the variety of child sizes, and a light weight and portable version of the five-point restraint. Furthermore, the seat design is compatible with either the LATCH or three-point seat belt system and has virtually no forward excursion with respect to that of the normal adult seat back; thus combining the advantages of both the booster seat and the five-point restraint for enhanced safety.

The present invention also allows for easy cleaning, and is virtually impossible to be installed incorrectly.

### PRIOR ART

Most forward-facing, add-on child restraint systems fall within two categories: (1) car seats and (2) booster or cushion seats. The particulars of these respective inventions are well-known and were described long ago. See, e.g., U.S. Pat. No. 2,777,502 issued to Travis on Jan. 15, 1947 (car seat); U.S. Pat. No. 4,033,622 issued to Boudreau on Jul. 5, 1977 (car seat); U.S. Pat. No. 3,136,579 issued to Hunter on Jun. 9, 1964 (booster seat); U.S. Pat. No. 4,461,510 issued to Cunningham et al. on Jul. 24, 1984 (booster seat). The prior art includes many of the most salient component features of the car seats and booster seats, including the five-point harness. See, e.g., U.S. Pat. No. 5,908,223 issued to Miller on Jun. 1, 1999.

As discussed supra, car seats and booster seats each include advantages and drawbacks. Prior art has attempted to combine features of car seats and booster seats to create a smaller, more portable child restraint system. Unlike the present invention, however, the majority of such embodiments rigidly attach in some fashion the seat-bottom to the seat back. See, e.g., U.S. Pat. No. 6,089,662, issued to Lambert et al. on Jul. 18, 2000; U.S. Pat. No. 5,964,502, issued to Stephens on Oct. 12, 1999; U.S. Pat. No. 5,158,337, issued to Leggett on Oct. 27, 1992; European Patent No. 1193111A2, issued to Maciejczyk on Jun. 26, 2001. This rigidity can lead to increased belt slack and injury risk to the child.

More recently, several inventions utilizing embodiments of the five-point restraint system have attempted to remedy some of the car seat's shortcomings described above, especially the portability issue. U.S. Pat. No. 8,210,617, issued to Aaron et al. on Jul. 3, 2012, describes the use of a thinner and lighter weight seat-bottom and back support that are disconnected from one another and thus can be folded and made more portable. However, the seat-bottom and seat back must, with use of pegs, be rigidly connected to each other at the intersection between the two. As a result, this invention becomes a hard shell when installed on the vehicle seat and suffers from the same defect described above, i.e., the seat-bottom and back move in tandem, allowing all child harness anchors to move in sync, which can compromise safety. Furthermore, this invention may be used only with the use of LATCH, not with a conventional adult 3-point seat belt. As such, it cannot comply with Federal Motor Vehicle Safety Standards No. 213.

Another portable version of the five-point restraint is described in U.S. Pat. No. 8,113,584, issued to Boyle et al. on Feb. 14, 2012. The invention consists of a seat-bottom, similar to a booster seat, while the shoulder straps are anchored to a flexible webbing member, which is mounted to the vehicle by an assembly of straps wrapped around the full length of the seat back and seat-bottom of the car. Other mounting options were presented as well. This restraint is even more difficult to install than a traditional car seat as the straps must be wrapped around the seat back and threaded through the opening between seat back and seat-bottom of the vehicle's adult seat. More importantly, the connection of the child's shoulder straps to another flexible strap (rather than a rigid member) allows movement of the belt anchors with respect to each other and the seat back in crash conditions, introducing slack and reduced protection for the child.

Another version of a portable five-point restraint issued to the same parties, U.S. Pat. No. 7,488,038 B2, issued to Boyle at al. on Feb. 10, 2009, is distinguishable for many of the same reasons. The device requires at least one additional belt length adjuster than the present invention and must be routed with webbing between the adult seat back and seat-bottom, which makes the child restraint more difficult to install. Similarly, it employs traditional routing of the webbing, which increases cost, complexity and the risk of improper installation. While one embodiment contemplates a bag in which the child seat can be stowed and transported, it lacks the built-in tote feature of the present invention. U.S. Pat. No. 7,488,038 B2 lacks the unique crisscross pattern of webbing of the present invention that prevents lateral movement of the device during side impacts. Finally, this invention cannot be used with a conventional adult 3-point seat belt and, therefore, does not comply with Federal Motor Vehicle Safety Standards No. 213.

Accordingly, a child restraint is needed that effectively combines the safety of a five-point restraint, as found in car seats, with portability, reduced size and ease of installation, as commonly found in booster seats. Additionally, fixed positioning of the child's shoulder belt anchors should be independent from that of the lower harness anchors. In this way, movement or deformation of the lower harness anchors (with accompanying slack) does not automatically entail movement of, and thus slack in, the upper shoulder harness points.

### BRIEF DESCRIPTION OF THE DRAWINGS

FIG. 1 is a perspective view of the present invention in the installed stage without a cover in cars equipped with a LATCH system;

FIG. 2 is a perspective view of the present invention in the installed stage with a cover in cars equipped with a LATCH system;

FIG. 3 is a front view of the present invention in the installed stage in cars equipped with a LATCH system;

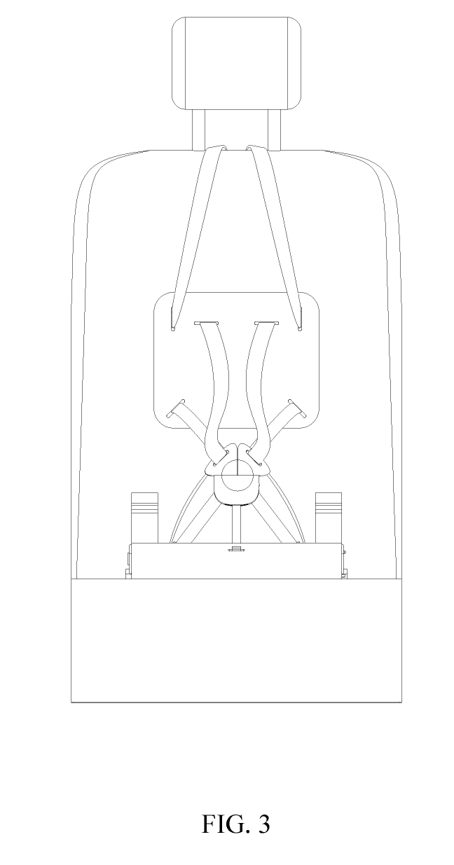

FIG. 4 is an exploded view of the present invention for cars equipped with a LATCH system;

FIG. 5 is a perspective view of the present invention for cars equipped with a LATCH system;

FIG. 6 is a front view of the present invention for cars equipped with a LATCH system;

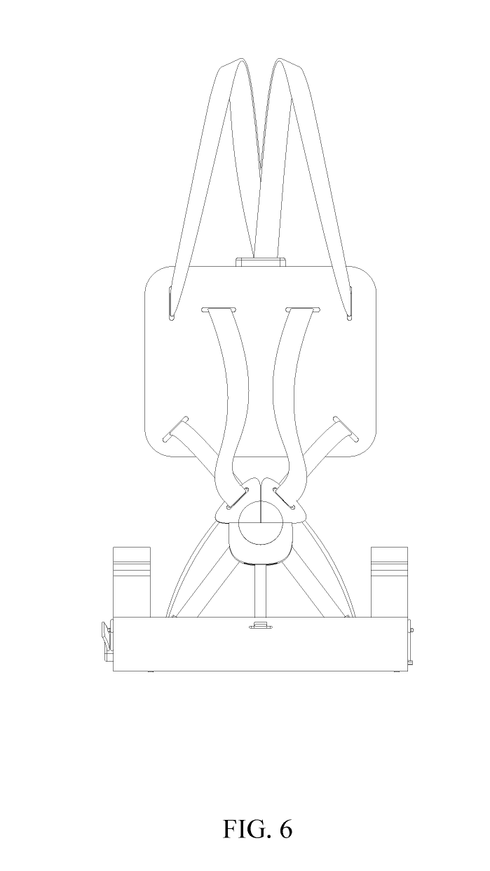

FIG. 7 is a rear-side view of the present invention for cars equipped with a LATCH system;

FIG. 8 is a perspective view of the installing procedure for the bottom seat for cars equipped with a LATCH system;

FIG. 9 is a front view of the back-plate component;

FIG. 10 is a bottom view of the seat-bottom, depicting the lower part of the harness system and lower hook attachments for cars equipped with a LATCH system;

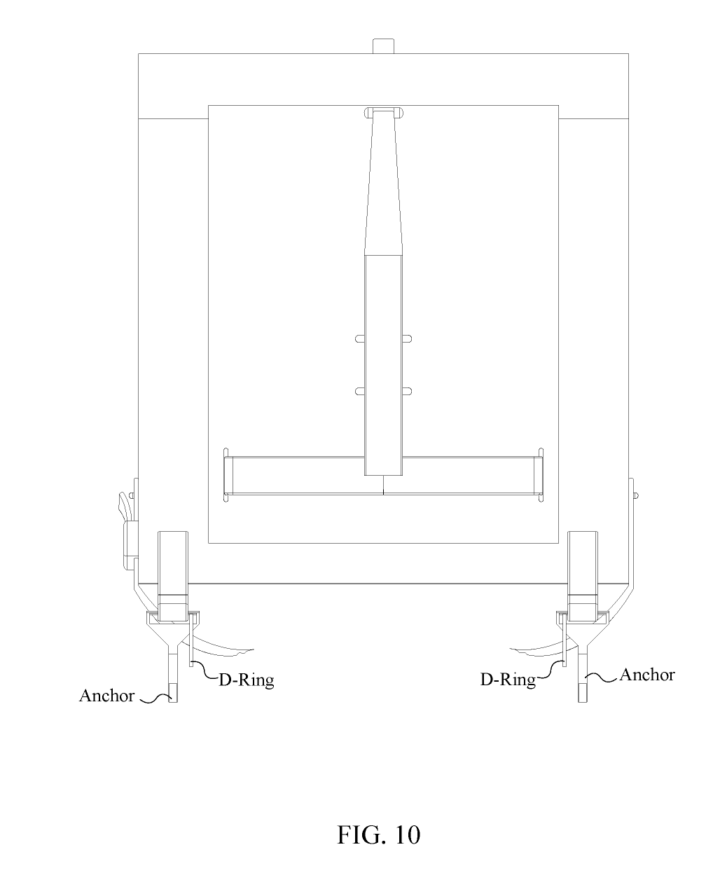

FIG. 11 is an isometric view from the bottom of the seat-bottom, depicting the lower part of the harness system and lower hook attachments for cars equipped with a LATCH system;

FIG. 12 is a right-side view of the present invention, depicting the implementation of a carrying case;

FIG. 13 is a perspective view of the present invention;

FIG. 14 is a rear perspective view of the present invention depicting the alternative anchoring system for the back-plate component for cars without a LATCH system;

FIG. 15 is a rear view of the present invention installed in a car seat without a LATCH system; and

FIG. 16 is a top view of the seat-bottom component of the present invention.

### DETAILED DESCRIPTION OF THE INVENTION

All illustrations of the drawings are for the purpose of describing selected versions of the present invention and are not intended to be exhaustive or limit the scope of the present invention to the precise forms disclosed in the following detailed description. Rather, the embodiments are chosen and described so that others skilled in the art may use their teachings.

The present invention is a passenger restraining system designed to restrain and protect children in an automobile during collisions. The present invention combines the safety of a five-point belt system of regular car seats for children, with the ease of use, portability, and adjustability of booster seats.

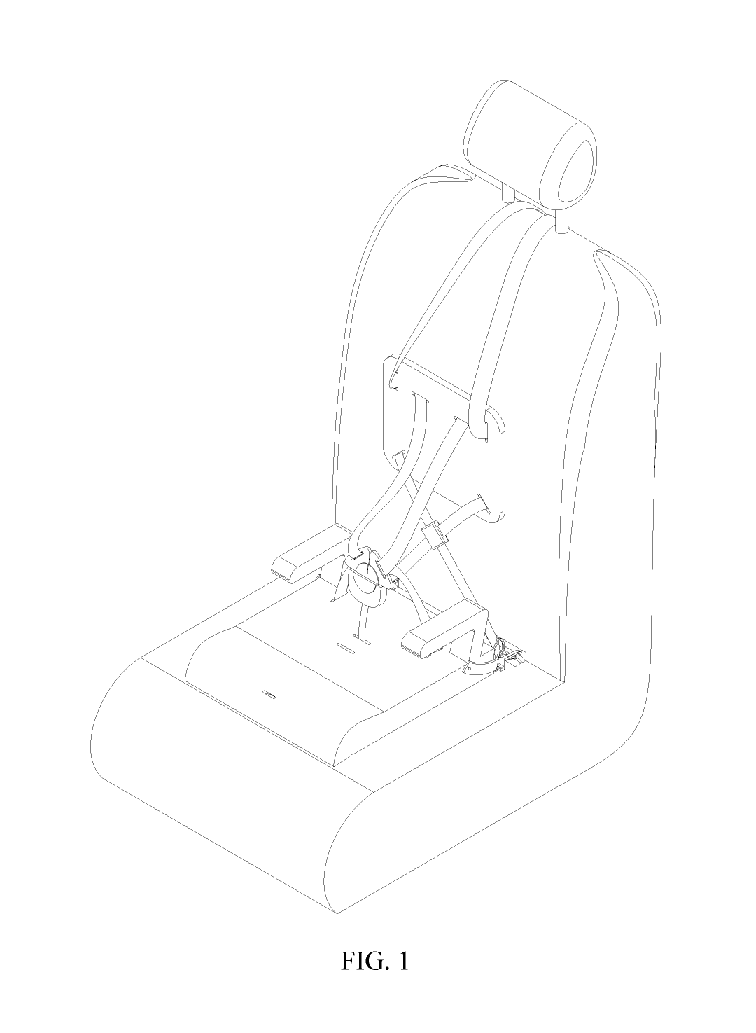

Referring to FIG. 1 a preferred embodiment of the present invention comprises a back-plate, an upper anchoring assembly, a seat-bottom, a lower anchoring assembly, a five-point harness, and a cover assembly. All webbing and belts utilized in the present invention comprise a strong fabric woven into a flat strip deemed appropriate for safety use in high speed vehicles such as automobiles; although, material composition, size, and color of the belts is subject to change in the final embodiment. The back-plate component is designed to allow the user to freely adjust and secure the shoulder straps to the correct height for the child; this is essential, as improper height positioning of the shoulder straps will result in ineffective restraint of the child and may lead to injury or death during vehicle collisions.

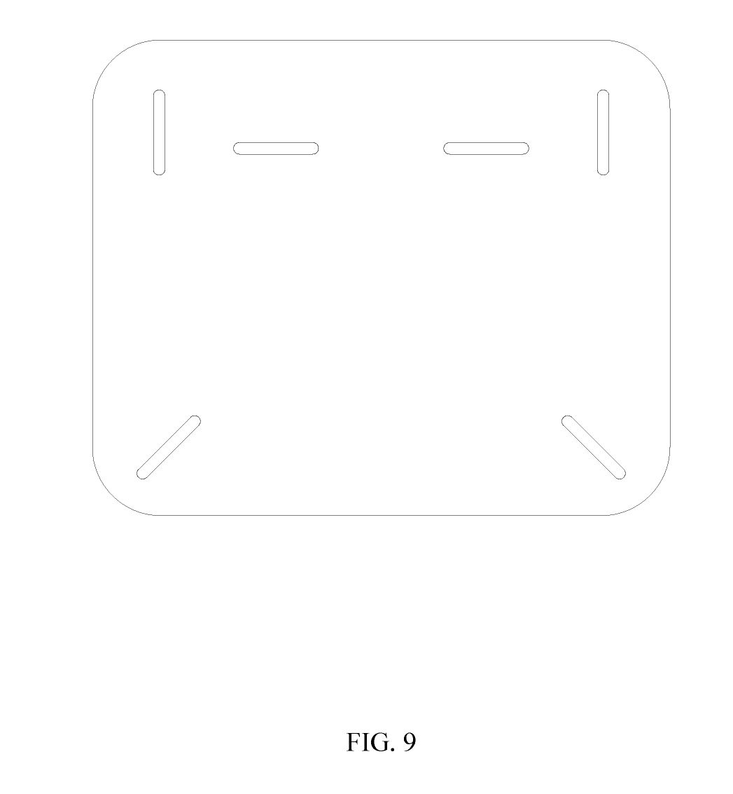

The back-plate comprises a trapezoidal extrusion of a certain thickness with rounded corners; the trapezoid is sized to correctly position a child's shoulder belt anchors and prevent forward and side movement of the back-plate. The back-plate may come in a variety of sizes, and may have additional padding and other accessories for head and thorax protection, or to provide cushioning for a sleeping child. The back-plate contains a plurality of through-hole slots distributed about the front surface as seen in FIG. 9. Each slot is designed for specific belt webbing positioning. The uppermost outboard, in the preferred embodiment, vertical slots in combination with the two lowermost angled slots are used to fasten the back-plate in the location of choice, while the horizontal slots between the two vertical, outboard slots are used to anchor the top of the child's shoulder straps. Using the top outboard and bottom slots as described above, the back-plate is positioned by two tethers. The uppermost outboard vertical slots may also be horizontally positioned.

First, a top tether, consisting of a single belt, originates from a belt length adjuster, from which it is threaded through the anchor hook opening. It continues to the front of the back-plate, where it passes from the front through the right outboard vertical slot, is routed along the rear of the back-plate, passes back to the front through the left outboard vertical slot, and finishes by threading through the same belt length adjuster it originated from.

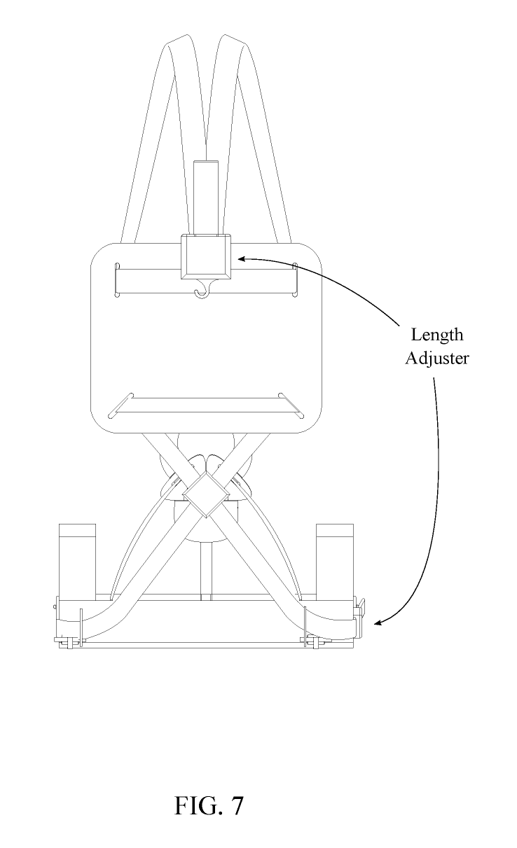

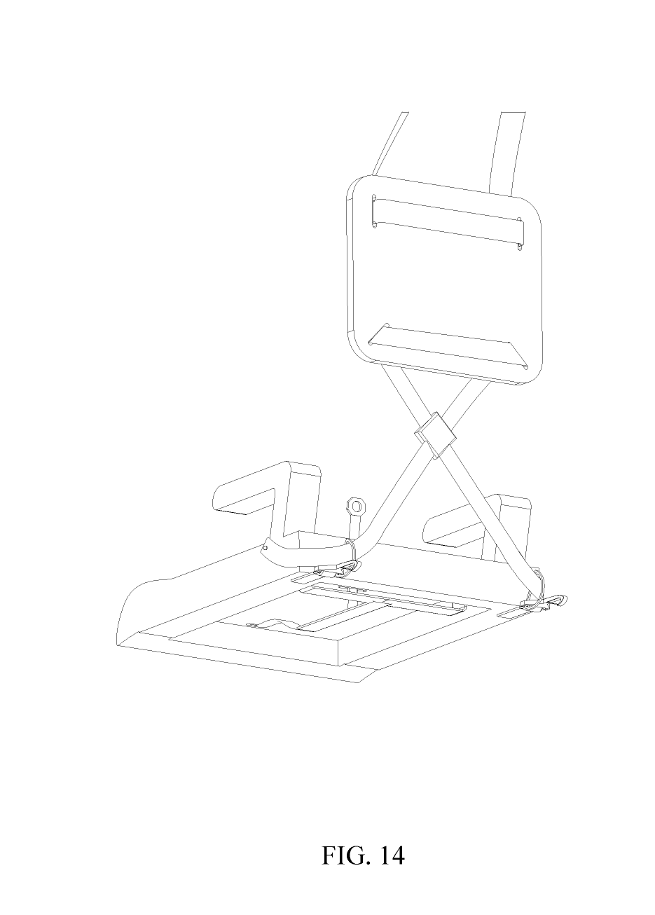

Second, a bottom tether which also consists of a single piece of webbing originates with a fixed attachment from a point near the left rear corner of the seat-bottom, preferably as far up and forward as the armrest and side of the seat-bottom allows. The webbing may be coupled to the left rear corner of the seat-bottom by any suitable means, such as for example, without limitation, by rivet, screw, cement, tack, slot and spindle, snap, hook and loop, zipper, button, melting, tongue and buckle. The bottom tether is then threaded through the opening of the anchor hook directly, or through a “D” shaped ring of certain thickness attached to the anchor hook, after which it continues through one loop of a double-loop-connector, then through the front of the right lower slot on the back-plate, continues along the rear of the back-plate, is threaded back to the front through the left bottom slot of the back-plate, crosses back over itself through a perpendicular loop of the double-loop-connector, passes through the right lower anchor-hook or a D-ring attached to the anchor-hook, and, finally, is threaded through a belt-length adjuster, which in turn is fixed to the seat-bottom near the right rear corner as in FIG. 14 and FIG. 7. The webbing may, again, be coupled to the right rear corner of the seat-bottom by any suitable means, such as for example, without limitation, by rivet, screw, cement, tack, slot and spindle, snap, hook and loop, zipper, button, melting, tongue and buckle. In their preferred embodiment, the D-rings are tie down rings shaped like a letter “D” or “O”, although their precise geometry, weight, finish and load may vary in the final embodiment, and fashioned from lightweight metallic material, such as, without limitation, aluminum, but may be fashioned from any rigid plastic, metallic, non-metallic or composite material. The D-rings may be coupled to the lower anchor-hooks bottom by any suitable means, such as for example, without limitation, by rivet, screw, cement, tack, slot and spindle, snap, hook and loop, zipper, button, melting, tongue and buckle, or other suitable connector. The bottom belt length adjuster may be on the right, the left or on both sides, to accommodate the use in either the left or right seating position.

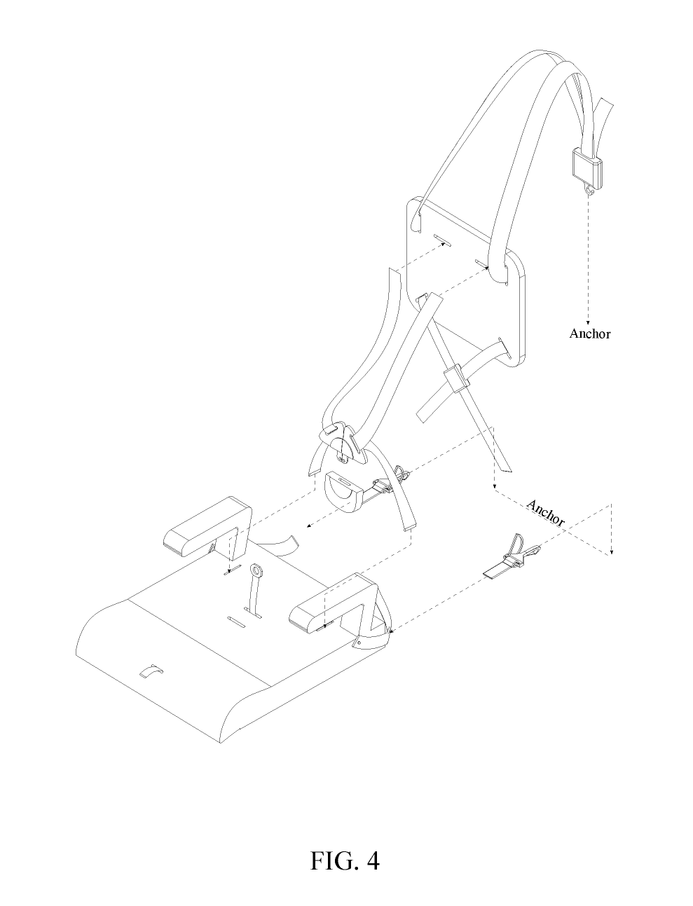

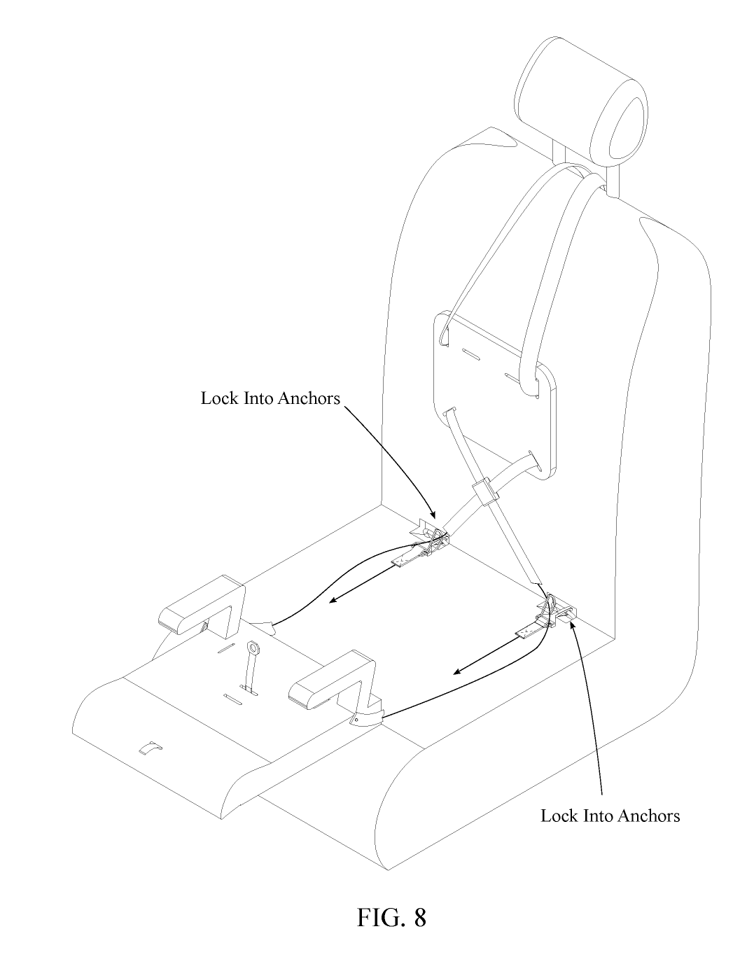

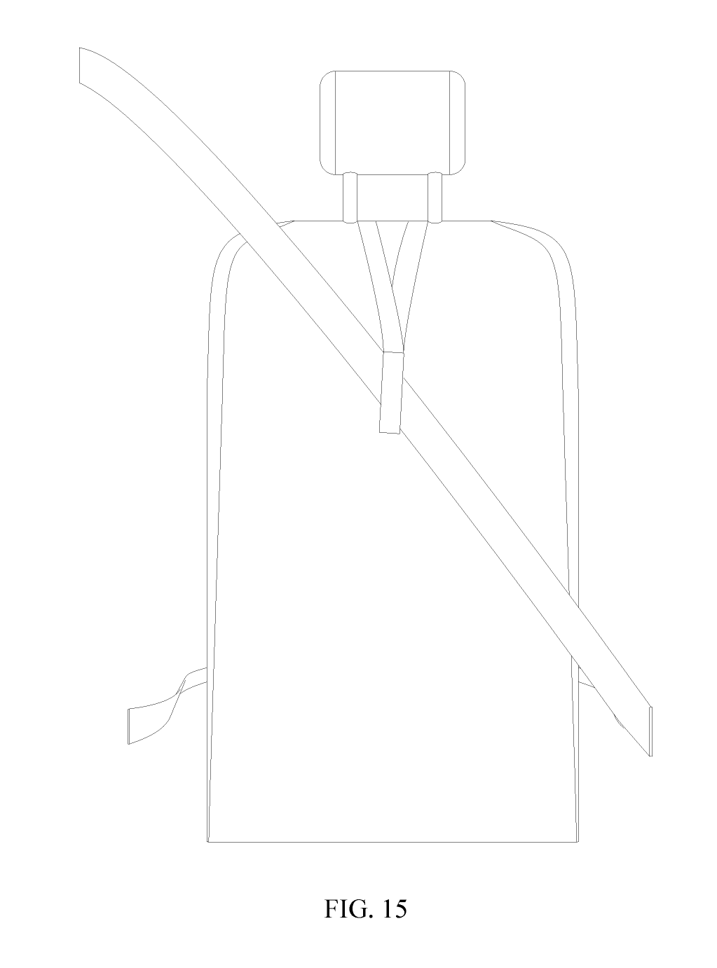

The top tether loop is routed from the vertical outboard slots in the back-plate around any head restraint or through the opening between an adjustable headrest and the top of the adult seat back, and locked onto either the top anchor of the LATCH system as in FIG. 4, or to the shoulder belt portion of the seat's three-point adult belt, when routed behind the adult seat back as shown in FIG. 15. The bottom tether's left and right endings are threaded through the corresponding seat-bottom's latching hooks with D-Rings, after which one of the endings continues to a fixture near the rear outside corner of the seat-bottom (one of the sides), while the other passes through a belt length adjuster before being fixed near the rear side corner of the seat-bottom (the other side), as depicted in FIG. 7 and FIG. 8. Another embodiment may include belt length adjusters on either side of the seat-bottom. The top tether loop and the bottom tether each contain a belt length adjuster (see FIG. 7), allowing for harness anchor height adjustment and tight installation of the back-plate and seat-bottom by adjustment of only these two tether lengths.

There are two horizontally coincidental slots approximately between the two vertical top-tether slots, one on either side an equal distance from the center line, which are utilized for the shoulder straps that run down either side of the child.

Near the lowermost left and right corner of the back-plate are two angled slot cutouts, in the preferred embodiment the angle is forty five degrees as seen in FIG. 9. The bottom tether webbing is used to anchor the seat-bottom to the adult vehicle seat, and after continuing in a criss-cross pattern using the double-loop-connector, is fed through these slots as seen in FIG. 14.

In its preferred embodiment, the back-plate comprises a rigid plastic material; other possible material compositions include, but are not limited to light aluminum, light steel, composites, and other comparable materials. The size, geometric design, thickness, and material composition of the back-plate are subject to change in the final embodiment of the present invention.

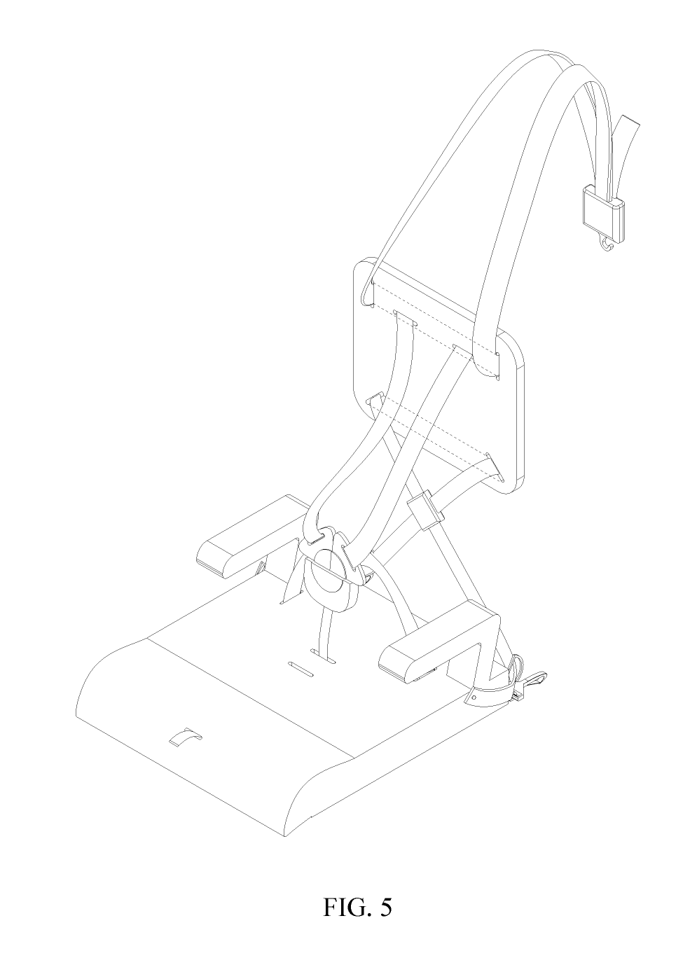

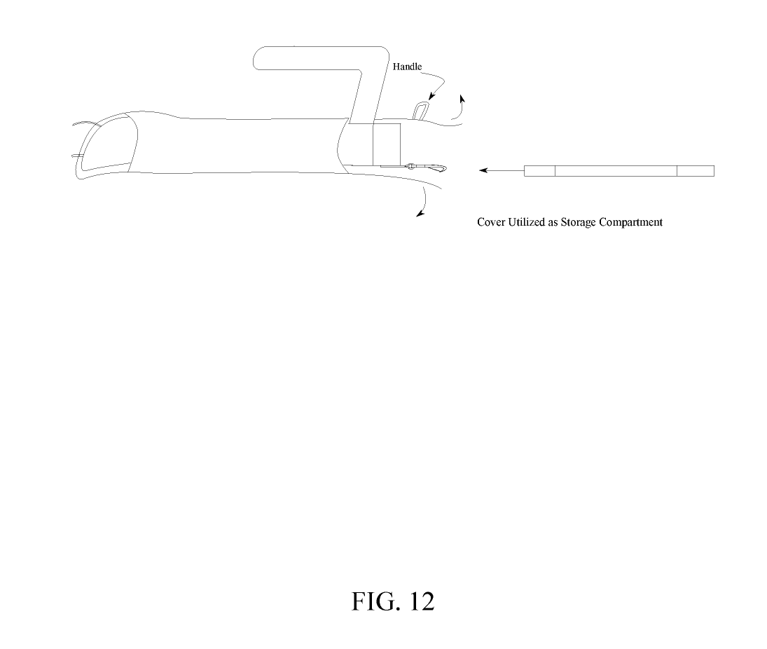

The seat-bottom comprises a rectangular extrusion of a certain length and width which enables introduction and placement of the child's buckle and hip straps. In its preferred embodiment, seat-bottom is fashioned from plastic, but may be fashioned from any rigid plastic, metallic, non-metallic or composite material. The seat-bottom may further contain a plurality of and varying indentations and recesses to reduce weight and increase comfort. Looking from the side perspective, the front edge is fully rounded to provide the child an ergonomic surface to rest their legs, as in FIG. 12. Cup holders may be inserted into the front corner position(s). Protruding from the top surface, on either side edge of the component, are two armrests as seen in FIG. 5. The armrests' vertical portion is angled slightly rearward to ensure contact of the top of the armrests with the adult seat back, preventing upward tipping of the seat-bottom during certain accident events. The armrests protrude forward from the left and right corner of the back region of the seat-bottom. In the preferred embodiment, the armrests are L-shaped. The armrests may comprise a strong, rigid material, and may be covered in a soft padding for contact with the child's arm.

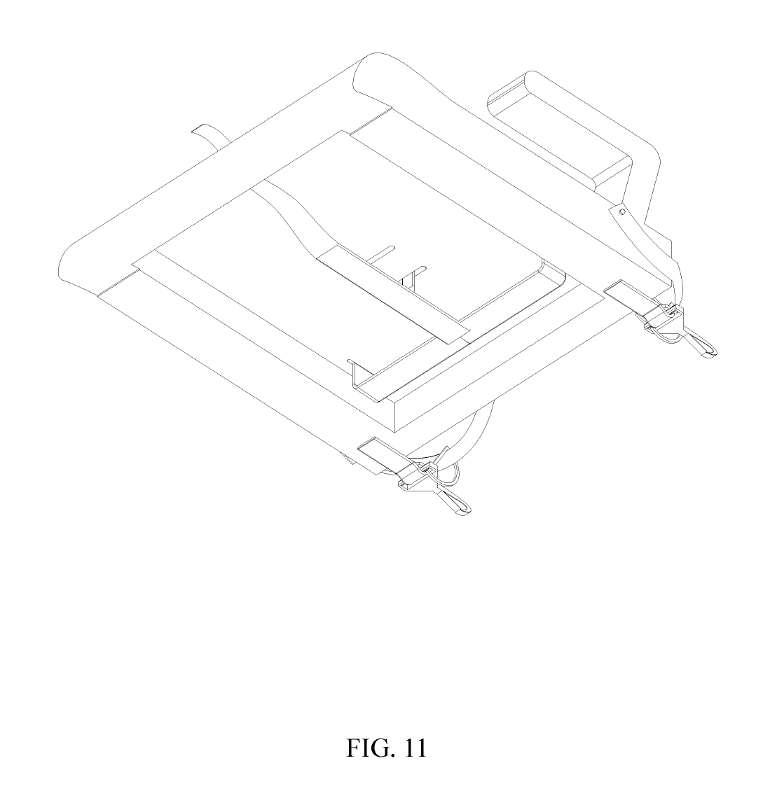

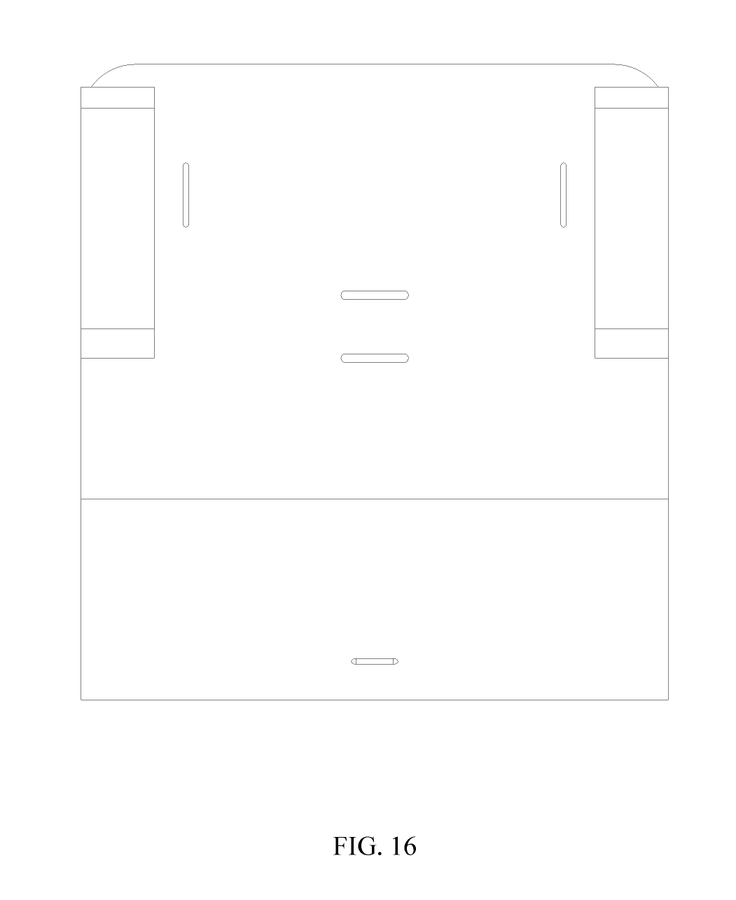

Distributed about the top surface of the seat-bottom is a plurality of slot holes. Similar to the back-plate, each slot hole is designed for a different belt webbing. Looking from the top perspective, there is a single slot near the left and one near the right armrest orientated along the length of the armrest as seen in FIG. 16, the left and right hip slots; distributed along the centerline is a plurality of slots orientated perpendicular to the length of the component, the groin slots. In the preferred embodiment, there are two slots in the middle of the component, the first and second groin slot. The groin belt webbing is threaded through either of these slots, depending on the size of the child. There is one additional slot located on the center front of the component, straight through the curved front edge as seen in FIG. 5; the child's belt adjuster slot is located towards the center. The adjuster slot restricts the movement of the belt length adjuster strap, which is threaded through it in some fashion, preventing slack in the car-seat installation or the child's seat belt system. This locking feature may be achieved through the use of a belt adjuster, a pivot slot with a release button, a locking slot with a release button, or any other comparable means. The seat-bottom may be connected to the vehicle seat by anchor-hooks which are fixed to the rear lower corners of the seat-bottom in some fashion. The location, shape and length of the anchor-hooks may vary to provide secure and tight installation of the seat-bottom. In the preferred embodiment, the hooks are fixed to the rear corners of the seat-bottom's underside with short straps as shown in FIG. 11. The seat-bottom is attached to the vehicle seat by connecting the hooks to the lower anchors of the seat's LATCH system as depicted in FIG. 8. The bottom tether, with its belt length adjuster, is applied to ensure a tight installation of the seat-bottom to the vehicle seat, in addition to aiding in the height adjustment and tight installation of the back-plate.

The five-point harness comprises a buckle assembly, a harness consisting of one single belt threaded through a plurality of slots on the seat-bottom, buckles, and the back-plate, multiple belt guides, and a harness tie or belt clip. The buckled harness restrains and protects the child during vehicle collisions. The buckle assembly comprises a left latch plate, right latch plate, and a buckle which is placed into one of the groin slots. The left latch plate and right latch plate contain a slot for the belt. The buckle contains a receptive cavity for the left and right latch plate. The buckle locks the latch plate components; the latch plates may be released with the press of a button on the buckle. As shown in FIG. 5, the belt portion consists of one piece of belt webbing threaded from the underside of the seat-bottom through the left and right hip slots, the left and right portions of the webbing then continue upward through the corresponding buckle slots to be anchored through the shoulder slots on the back-plate. The belt portion underneath the seat-bottom is connected perpendicularly to the adjuster strap which in turn is threaded through the belt adjuster slot of the seat-bottom. The configuration and belt threading is seen in FIG. 5 and FIG. 11. Pulling on the adjuster strap will tighten and constrict the child's harness which will ensure a tight, snug fit around the child, which in turn is essential for proper functioning of the restraint in vehicular accidents. The buckle design, locking mechanism, receptive cavities, material composition, and size are subject to change in the final embodiment of the present invention. Additionally, the left and right shoulder straps may contain a plurality of three-bar slides, tilt lock adjusters, belt guides, padded cushions, and other belt accessories which would increase the comfort level of the child. In the preferred embodiment, the left and right shoulder straps contain a belt clip consisting of two belt guides that are horizontally attached via female-male system similar to a quick release buckle.

The present invention may be attached to the vehicle's car seat in two main ways; using the adult safety belt of the vehicle's seat, or using the LATCH system that comes standard with all newer vehicles. If the car is equipped with the LATCH system, it is best to utilize the associated attaching mechanism. If the car is not equipped with the LATCH system, the adult safety belt of the seat should be utilized to secure the present invention.

To attach the back-plate to the adult vehicle seat, two different tethers are used, the upper anchor tether loop and the lower anchor tether. The upper anchor tether consists of a single belt which is looped around, originating from a belt length adjuster, which is then threaded through the anchor hook, and continues for a certain length before entering one of the vertical outboard slots from the front, continues along the rear portion of the back-plate, passes through the other vertical outboard slot from back to front, and finishes, after a certain length being threaded through the same belt length adjuster. This loop may be routed around the head restraint or through the opening between the adjustable head restraint and the top of vehicle seat back to the attachment point at or near the top of the vehicle's seat back.

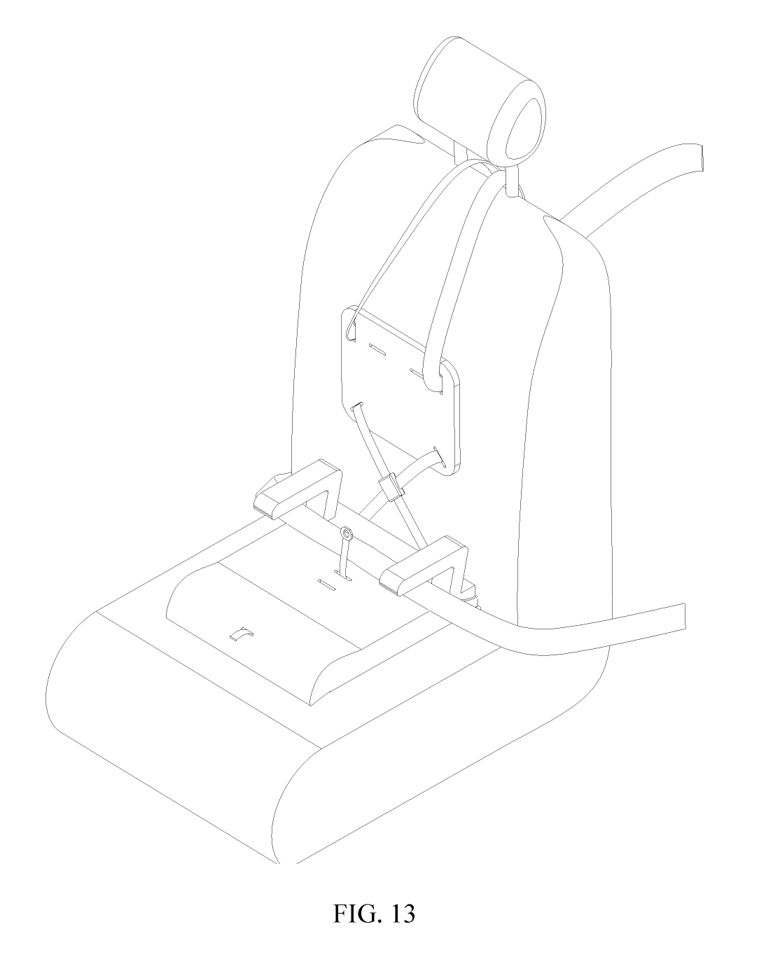

Referring to FIG. 4, if the vehicle is equipped with the LATCH system, the anchor hook couples to the ‘upper tether’ anchoring element of the LATCH system. The location of the anchoring element depends on the vehicle, and may vary from the rear side of the vehicle's seat back, to the vehicle's rear wall, or the floor directly behind the vehicle seat. In the absence of the LATCH system, the top tether loop contains (instead of, or in addition to the anchor hook) a belt-locking element which attaches to the shoulder portion of the existing adult safety belt of the vehicle's seat, which is positioned and locked in place behind the seat back as depicted in FIG. 13 and FIG. 15.

The lower tether is threaded through the lower left and right angled slots of the back-plate and crisscrosses itself using a double-loop connector as described previously. The left and right bottom ends are threaded through either the anchor hooks themselves, or through D-rings attached to the seat-bottom anchor-hooks at both rear corners, then fastened to either side of the seat-bottom as depicted in FIG. 7 and FIG. 14. At least one of said bottom ends is threaded through a belt length adjuster before attaching to the side of the seat-bottom as seen in FIG. 7. The top tether loop's belt length adjuster is in close proximity to the belt hook; it adjusts the height of the back-plate and the harness anchors. Furthermore, it provides tight installation of the back-plate in conjunction with the lower tether, which minimizes movement of the back-plate with its shoulder strap anchors to provide optimal protection for the child. Minimal movement of the back-plate is needed to provide optimal protection for the child in a wide range of accident events. Using both top and lower tethers, the shoulder anchors may be positioned at any height of choice.

When equipped with the LATCH system, the seat-bottom is connected to the motor vehicle by fastening the seat-bottom anchor hooks to the lower LATCH anchors of the vehicle seat, and tightening the lower tether with the belt length adjuster as shown in FIG. 7 and FIG. 8. In the absence of the LATCH system, the seat-bottom component is fastened to the vehicle seat by threading the lap portion of the adult safety belt under the armrests as seen in FIG. 13. The shoulder portion of the adult safety belt is routed behind the vehicle's seat back and used to hold the back-plate in place via the top tether loop with a belt-locking clip.

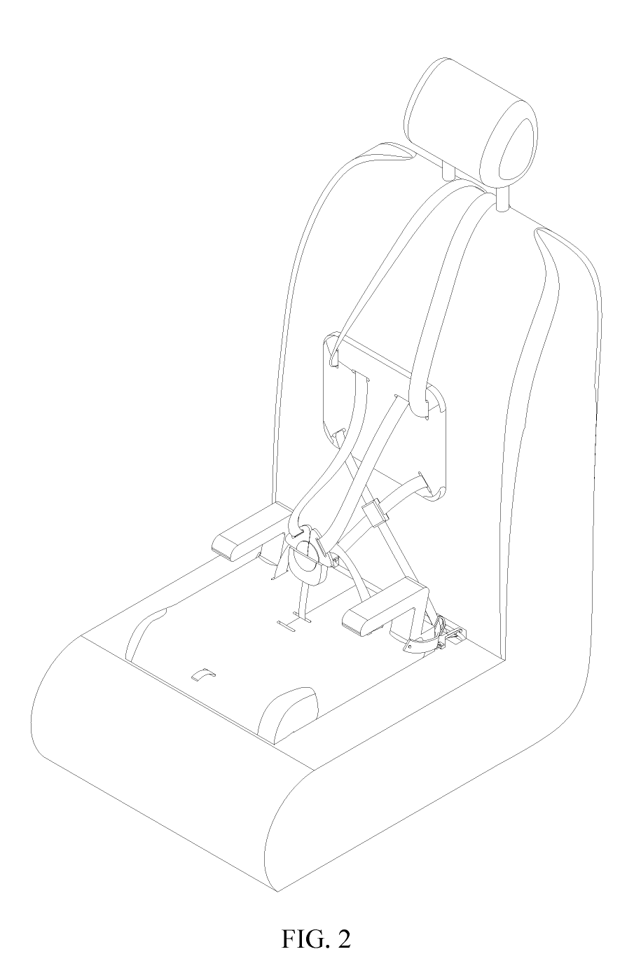

The cover assembly comprises a back-plate cover and a seat-bottom cover. The back-plate cover comprises a partially cushioned/padded envelope of flexible cloth or other suitable material shaped to the size of the back-plate with Velcro or zipper-like edgings so as to cover the whole component. The front, or child-facing side, of the cover includes padding (e.g., foam, batting and gel) while the back remains unpadded. Slits are provided into the fabric from the edges of all slots to the edge of the fabric as shown in FIG. 2 to ensure the cover may be removed without disengaging any of the seat belts. The seat-bottom cover is similar to the back-plate cover; the cushioned/padded fabric is shaped to cover the top and side surfaces ranging from the rear end over the front contoured portion of the seat-bottom. The fabric continues unpadded along the underside back to the rear. Velcro or zipper-like couplings are located at the back end to ensure that the cover may be quickly removed without disengaging the seatbelts. The back end Velcro or zipper-like coupling may be utilized as a storage compartment for the back-plate as seen in FIG. 12. A plurality of handles or a shoulder strap may be connected to the fabric cover near the back coupling to allow the invention to implement a carrying case after storage of the back-plate into the seat-bottom opening.

Although the present invention has been explained in relation to its preferred embodiment, it is to be understood that many other possible modifications and variations can be made without departing from the spirit and scope of the invention as herein described. This application is, therefore, intended to cover any variations, uses or adaptations of the invention using its general principles. Further, this application is intended to cover such departures from the present disclosure as come within known or customary practice within the art to which this disclosure pertains.

What is claimed is:

1. A portable child restraint system configured to attach securely to a vehicle seat and restrain a child's body from significant movement within the restraint system, and further comprising:
a back-plate;
an upper anchoring assembly;
a seat-bottom;
a lower anchoring assembly;
a five-point harness; and
a cover assembly.

2. The portable child restraint system of claim 1, wherein said back-plate:
comprises a rigid, trapezoidal extrusion containing a plurality of through hole slots distributed about the front surface designed for specific belt webbing positioning;
wherein said through hole slots include two lowermost angled slots, which are used to fasten said back-plate in the location of choice; and two center horizontal slots, which are used to anchor the top of the child's shoulder straps; and two uppermost slots, which are used to anchor the top of said back-plate to the vehicle seat; and
wherein said back-plate comprises the means to rigidly secure and maintain the shoulder harness anchors in the optimal position.

3. The portable child restraint system of claim 1, wherein said upper anchor assembly:
comprises an anchor tether of a single belt loop extending vertically from the back-plate of claim 1 through a belt length adjuster and an anchor hook for attachment to an attachment point at or near the top of a seat back in a vehicle;
wherein said single belt loop may be routed around the head restraint of the vehicle seat back or through the opening between an adjustable head restraint and the top of the vehicle seat back to an attachment point at or near the top of a seat back; and
wherein the upper anchor assembly allows for infinite height adjustment of the shoulder harness anchors of the back-plate of claim 2.

4. The portable child restraint system of claim 1, wherein the back-plate of claim 2 is connected to the seat-bottom by a crisscross pattern of webbing that prevents lateral movement of the device during side impacts.

5. The crisscross device of claim 4, further comprising a double-loop-connector:
wherein said double-loop-connector comprises two webbing loops fastened perpendicular to one another;
wherein each portion of the crisscross pattern of webbing of claim 4 is threaded through one of the webbing loops of said double-loop-connector;
wherein said double-loop-connector holds the crisscross pattern of webbing in place so that said crisscross remains configured correctly at all times relative to the position of the back-plate of claim 2 and regardless of the length of the child's shoulder straps;
wherein said double-loop-connector allows adjustment of the length of the crisscross pattern of webbing without altering the crisscross configuration.

6. The criss-cross device of claim 4, further comprising a lower anchoring assembly attached to the seat-bottom of claim 1:
wherein said lower anchoring assembly comprises the opposing ends of the crisscross pattern of webbing, each of which passes through either a lower anchor hook or a D-ring attached to the lower anchor hook at both rear corners of the seat-bottom of claim 1;
wherein at least one side of said webbing of the lower anchoring assembly, after passing through either a lower anchor hook or a D-ring at the corners, is fed through a belt length adjuster;
wherein said belt length adjuster may attach to either webbing member of the lower anchoring assembly or, for convenience, two belt length adjusters may attach to both webbing members at the corners of the seat-bottom; and
wherein said webbing, after passing through either or both belt length adjustors, is permanently coupled or fastened to the opposite corners of the seat-bottom as far up and forward as the armrest and side of the seat-bottom allow.

7. The lower anchoring assembly of claim 6:
wherein said lower anchoring assembly tightly secures the seat-bottom of claim 1 to the vehicle-seat;
wherein said lower anchoring assembly, in conjunction with the upper anchoring assembly of claim 3, tightly secures the back-plate of claim 2 to the vehicle seat;
wherein said lower anchoring assembly, in conjunction with the upper anchoring assembly of claim 1, adjusts the height of the back-plate of claim 2; and
wherein the foregoing adjustments in this claim 7 may be accomplished using a single belt length adjuster located at either or both lower corners of the seat-bottom of claim 1.

8. The portable child restraint system of claim 1, wherein said seat-bottom is independent from, and not rigidly fixed to, the back-plate of claim 2.

9. The seat-bottom of claim 8, further comprising:
anchor-hooks located at the underside of each lower corner of the seat-bottom, wherein said lower anchor-hooks are each permanently coupled to the seat-bottom at the end of short, flexible straps or tethers;
said straps extend horizontally from the back of the seat-bottom, allowing the lower anchor-hooks to attach to an attachment point at or near the bottom of an adult seat back in a vehicle and tightly secure the seat-bottom to the vehicle seat;

10. The lower anchor-hooks of claim 9, further comprising:
a D-ring coupled to each of the lower anchor-hooks;
said D-rings are used to thread the end of each belt portion of the criss-cross device of claim 3, which then passes through a seat-belt length adjuster and affixes to each side of said seat-bottom with the lower anchoring assembly of claim 6;
said D-rings further allowing the lower anchoring assembly of claim 6 to securely attach to the lower anchor-hooks of claim 9 and secure the portable child restraint system to the vehicle seat.

11. The seat-bottom of claim 8, further comprising an armrest on each side extending vertically from the top of the seat-bottom, each of which is angled rearward and in constant contact with the vehicle seat as to prevent upward tipping of the seat-bottom;

12. The seat-bottom of claim 8, further enabling introduction and placement of the child's buckle and hip straps using a plurality of through-holes, wherein said through-holes include:
a single slot near the left and one near the right armrest, which are used to route the hip portion of the five point harness of claim 13;
a plurality of slots distributed along the centerline of the seat-bottom of claim 8, which are used to attach the groin buckle; and
a single slot centered in the foremost portion of said seat-bottom of claim 8, through which a harness-length adjuster strap is routed and locked into position.

13. The portable child restraint system of claim 1, wherein said five-point harness employs a reconfigured routing method originating at the top of the back-plate of claim 2, which reduces the length of the harness webbing, prevents entanglement and incorrect routing of the harness webbing, and eliminates the need for harness end loops and adjustment clip, which are found in typical car seats.

14. The five-point harness of claim 13 and its reconfigured routing method, having an upper portion and a lower portion, wherein:
the upper portion comprises a single belt originating from rear of one of the center, horizontal through holes in the back-plate of claim 2, and looping through one of the buckle's latch plates, then into the seat-bottom at one of the hip slots, along the underside of the seat-bottom of claim 8, up through the other hip slot, back through the other latch plate and terminating again through the other center horizontal through hole in the back-plate of claim 2; and
the lower portion comprises a buckle anchored to the center of the seat-bottom of claim 8, using one of the center slots in the seat-bottom of claim 12, to receive the latch plate the lower portion further comprises a single adjuster strap, which is permanently affixed to, and originates from, the center of the belt portion underneath the seat-bottom and is threaded through the belt adjuster slot at the front of the seat-bottom, allowing the adjuster strap to be pulled to tighten and constrict the child's harness.

15. The portable child restraint system of claim 1, wherein the seat cover assembly comprises a back-plate cover and a seat-bottom cover, both of which are removable without disengagement of tethers or harness webbing.

16. The seat cover assembly of claim 15, further comprising:
a partially cushioned/padded piece of fabric shaped to the size of the back-plate of claim 2 with Velcro or zipper-like edgings so as to cover the whole component, front with padded cover and back unpadded, with slits into the fabric from the edges of all through slots to the edge of the fabric to ensure the cover may be removed without disengaging any of the belts; and
a cushioned/padded fabric shaped to cover the top surface ranging from the rear end over the front contoured portion of the seat-bottom of claim 8; which fabric continues padded or unpadded along the underside back to the rear; and which top and bottom coverings are connected together at the sides, with a slit sufficiently wide to enable the buckle to pass through, while the rear end of the top and bottom contains a Velcro or zipper-like coupling to ensure that the cover may be quickly removed without disengaging the belts.

17. The seat cover assembly of claim 15, wherein said seat-bottom cover may be utilized as a storage compartment for the back-plate, harness and tethers by opening the rear-end coupling and inserting said back-plate, harness and tethers, and which further comprises a plurality of handles or a shoulder strap connected to one or more of the outer edges of the fabric cover of the seat-bottom to allow the invention to implement a carrying case after storage of the back-plate, harness and tethers into the seat-bottom opening.

18. A method for stowing and transporting a portable child safety seat with five-point restraint, said portable child safety seat having a seat-bottom cover that may be utilized as a storage compartment for the back-plate, harness and tethers of the portable child safety seat and a plurality of handles or a shoulder strap connected to one or more of the outer edges of the fabric cover of the seat-bottom, comprising the steps of:
opening the rear-end coupling of the seat-bottom cover;
inserting the back-plate, harness and tethers of the portable child safety seat into the rear-end coupling of the seat-bottom cover wherein said back-plate, harness and tethers are stowed inside of said seat-bottom cover;
lifting the portable child safety seat in its stowed position by at least one of the plurality of handles or shoulder strap connected to one or more of the outer edges of the fabric cover of the seat-bottom.
